(19) United States
(12) Patent Application Publication
(10) Pub. No.: US 2011/0228083 A1
(43) Pub. Date: Sep. 22, 2011

(54) OUTDOOR SECURITY COMMUNICATION DEVICE

(75) Inventor: Chun-Hsu Su, Taipei City (TW)

(73) Assignee: AMROAD TECHNOLOGY, INC., Taipei County (TW)

(21) Appl. No.: 12/725,594

(22) Filed: Mar. 17, 2010

(51) Int. Cl. H04N 7/18

(52) U.S. Cl. 348/143; 348/373; 348/E07.085

(57) ABSTRACT

An outdoor security communication device comprises: a fixing substrate; a base that is combined with the fixing substrate and has a first waterproof washer, a groove and an anti-thief shrapnel being further disposed on the base; an upper lid combined with the base to form an accommodating space; and a cover plate covering over the surface opposite to the one where the upper lid and the base are combined. A main circuit board, an amplifier module, a shooting module, an audio input module and a button module are further disposed in the accommodating space for operation of the outdoor security communication device.

### BACKGROUND OF THE INVENTION

1. Technical Field

The present invention is related to an outdoor security communication device, more particularly to an outdoor security communication device with the functions of waterproof and anti-thief.

2. Description of Related Art

In this modern society, with the gradually rising life quality, living comfort and convenience, in particular, are indispensables. Therefore, human beings take advantage of the rapidly developed technology to create many inventions for further comforting and facilitating our daily life, and among others, outdoor security communication devices would be one typical example.

The most primitive outdoor security communication devices only allowed for exchange of audio messages, such as verbal exchange among users and the audio data transmitted by analog signals. Then, video-audio outdoor security communication devices were developed, and users could obtain audio and video messages simultaneously so as to increase the conveniences of operations.

Nowadays, with the advent of the digital era, digital data have become the mainstream in terms of data transmission of outdoor security communication devices, and because of the high variability and flexibility of digital transmission, outdoor security communication devices are no longer limited to dialogues from doors to indoors, or vice versa, but can serve as a surveillance device, a monitoring device or a security device.

Although the functions of the existing outdoor security communication devices have been highly developed, while in rainy days, water or humidity may permeate into the outdoor security communication devices through shell gaps thereof so as to cause damages of electronic components of the outdoor security communication devices. Accordingly, there is a need to provide an outdoor security communication device for preventing water permeation.

In addition, since such outdoor security communication device is installed outdoors, it can be easily taken apart from the wall it mounts on and stolen by one with a simple tool, thus suffering from a very high theft rate. In light of this, there is a need to provide an outdoor security communication device with an anti-thief function in order to reduce the theft rate.

### SUMMARY OF THE INVENTION

In view of the aforementioned problems and shortcomings of the prior art, the inventor, with years of accumulated experiences, exerted imagination and creativity, and after numerous trials and modifications, came up with an outdoor security communication device with an improved structure of the present invention.

The main objective of the present invention is to provide an outdoor security communication device with an improved structure for reducing water permeation through the disposition of waterproof elements, thereby protecting the internal electronic components.

Another objective of the present invention is to provide an outdoor security communication device with an improved structure for realizing an anti-thief mechanism through the disposition of anti-thief elements, thereby reducing the theft rate.

Thus, the present invention discloses an outdoor security communication device with an improved structure, wherein the outdoor security communication device comprises: a fixing substrate being a plate structure and attached to a particular outside wall surface; a base being combined onto said fixing substrate and comprising: a first waterproof washer being disposed on peripheries of said base and said fixing substrate, said peripheries making the combination of said base and said fixing substrate, in order to prevent that water permeates from a joint border of said base and said fixing substrate into said outdoor security communication device; a groove being disposed on a surface of said base, which combining with said fixing substrate by said surface, and having an inclined plane, wherein the water is removed by said groove and said inclined plane; an anti-thief shrapnel being disposed on the surface where said base is combined with said fixing substrate, wherein when said base and said fixing substrate are separated by an external force, said anti-thief shrapnel being then deformed so as to trigger an anti-thief system; an upper lid being combined with said base to form an accommodating space, wherein a second waterproof washer is disposed on a joint border of said upper lid and said base for preventing that the water permeates from said joint border of said upper lid and said base into said accommodating space; a cover plate covering on a surface opposite to the surface where said upper lid is combined with said base for protecting said upper lid from being damaged due to impact; a main circuit board being disposed in said accommodating space for managing electric power and information; an amplifier module being disposed in said accommodating space for broadcasting audio messages; a shooting module being disposed in said accommodating space for capturing images; an audio input module being disposed in said accommodating space for inputting audio messages; and a button module being disposed in said accommodating space and exposed on the surfaces of said upper lid and said cover plate for sending visiting messages.

### BRIEF DESCRIPTION OF THE SEVERAL VIEWS OF THE DRAWINGS

FIG. 1 is a perspective assembly diagram of an outdoor security communication device according to a preferred embodiment of the present invention.

FIG. 2 is another perspective assembly diagram of the outdoor security communication device from a different angle according to the preferred embodiment of the present invention.

FIG. 3 is an exploded view of the outdoor security communication device according to the preferred embodiment of the present invention.

FIG. 4 is another exploded view of the outdoor security communication device from a different angle according to the preferred embodiment of the present invention.

### DETAILED DESCRIPTION OF THE INVENTION

In order to achieve the aforementioned objectives and effects, the inventor performed a structural improvement on the conventional outdoor security communication devices and added waterproof and anti-thief related elements, to accomplish an outdoor security communication device with improved structure of the present invention. The outdoor security communication device according to a preferred embodiment of the present invention is described in detail to illustrate the overall structure and technical spirit of the present invention.

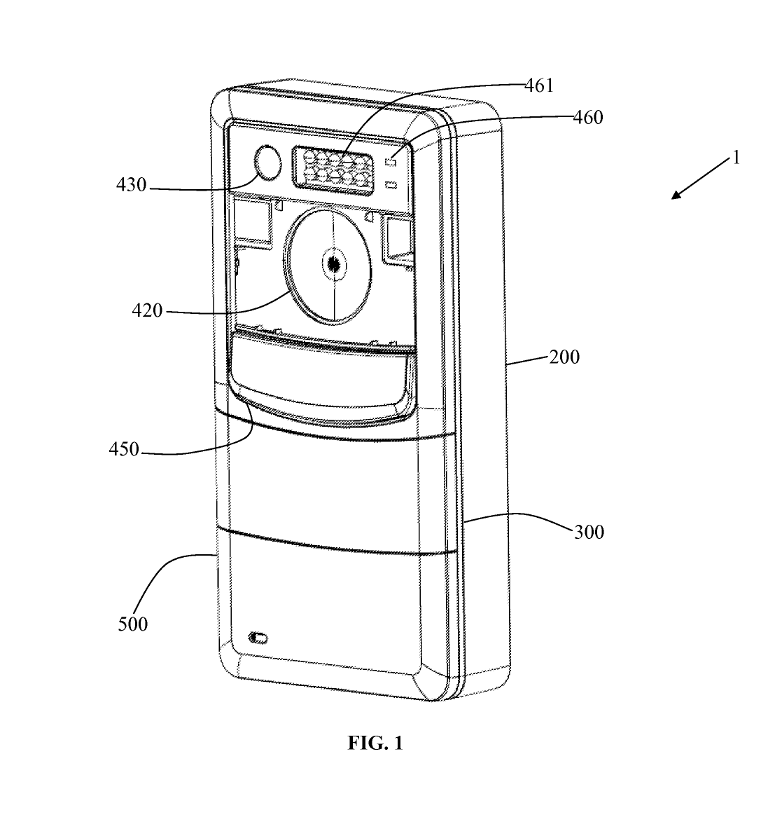

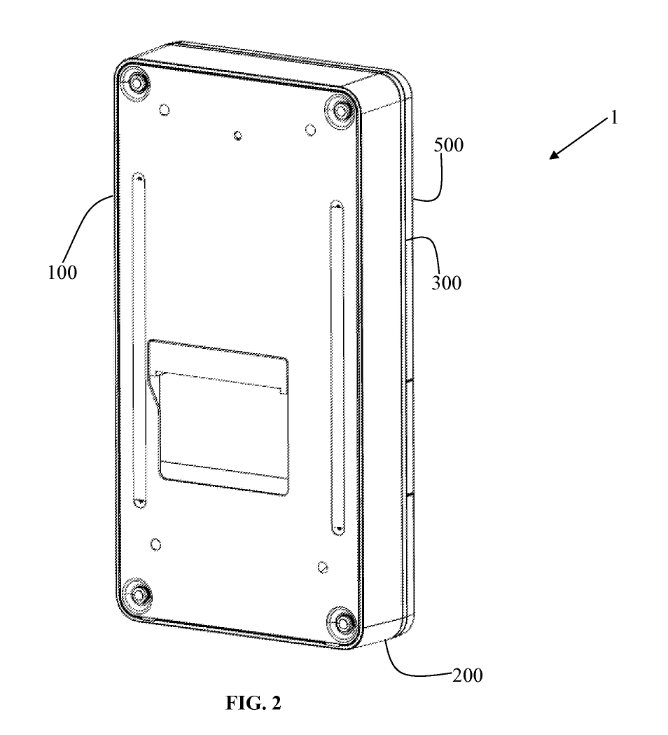

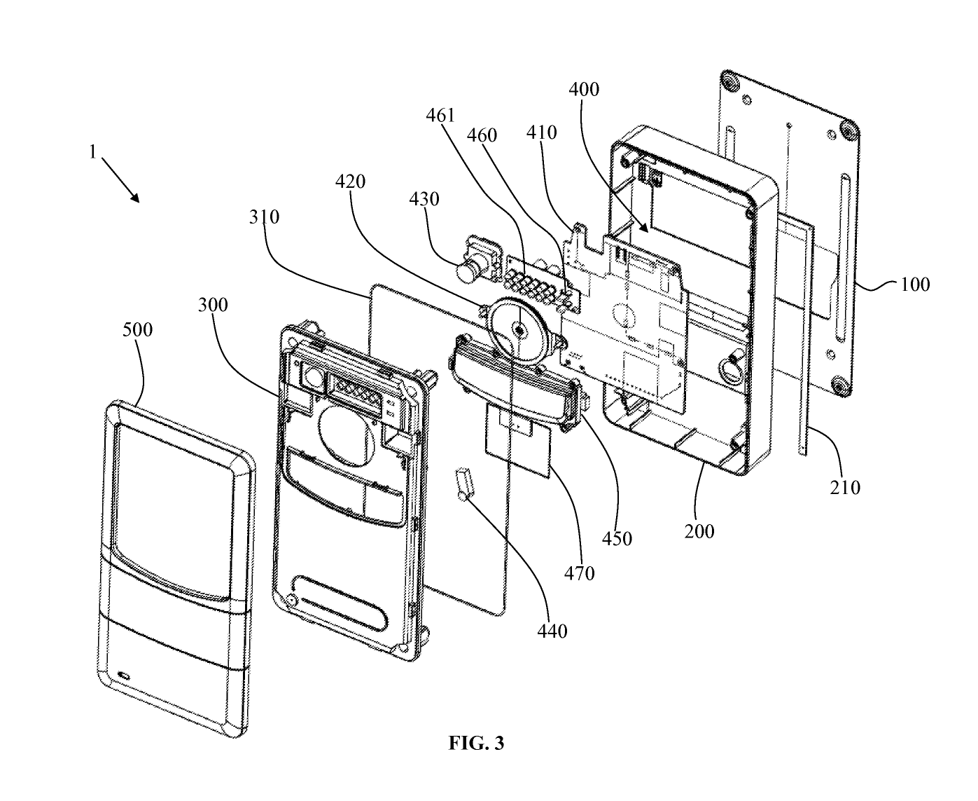

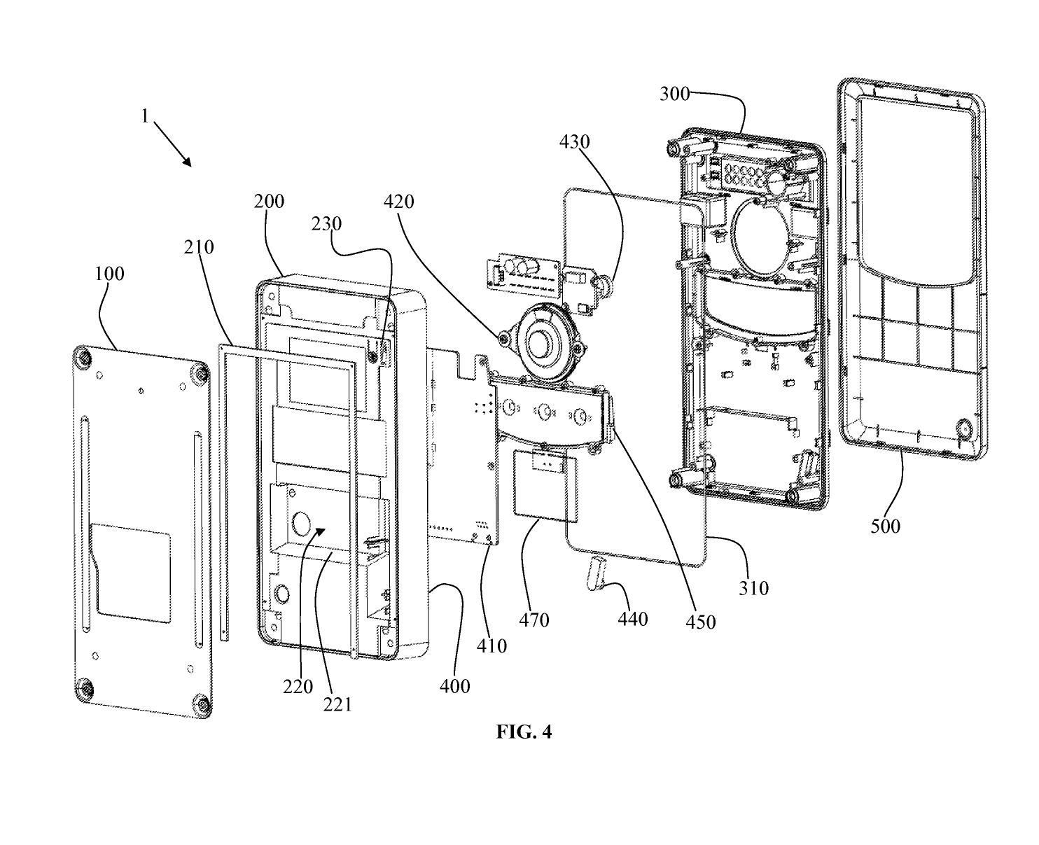

Refer to FIG. 1 to FIG. 4 simultaneously. FIG. 1 is a perspective assembly diagram of an outdoor security communication device according to a preferred embodiment of the present invention. FIG. 2 is a perspective assembly diagram of the outdoor security communication device from a different angle according to the preferred embodiment of the present invention. FIG. 3 is an exploded view of the outdoor security communication device according to the preferred embodiment of the present invention. FIG. 4 is an exploded view of the outdoor security communication device from a different angle according to the preferred embodiment of the present invention.

As shown in the figures, the outdoor security communication device 1 comprises the following components.

A fixing substrate 100 is a plate structure and attached to a particular outside wall surface, wherein said fixing substrate 100 is made of metal, and said fixing substrate 100 is attached to said particular outside wall further by means of screw fastening.

A base 200 is combined with said fixing substrate by means of screw fastening. The base further comprises a first waterproof washer 210 being disposed on peripheries of said base 200 and said fixing substrate 100, said peripheries making the combination of said base 200 and said fixing substrate 100, in order to prevent that water permeates from a joint border of said base 200 and said fixing substrate 100 into said outdoor security communication device 1; a groove 220 being disposed on a surface of said base 200, which combining with said fixing substrate 100 by said surface, and having an inclined plane 221, wherein the water is removed by said groove 220 and said inclined plane 221; and an anti-thief shrapnel 230 being disposed on the surface where said base 200 is combined with said fixing substrate 100, wherein when said base 200 and said fixing substrate 100 are separated by an external force, said anti-thief shrapnel 230 being then deformed so as to trigger an anti-thief system.

An upper lid 300 is combined with said base 200 to form an accommodating space 400, wherein a second waterproof washer 310 is disposed on a joint border of said upper lid 300 and said base 200 for preventing that the water permeates from said joint border of said upper lid 300 and said base 200 into said accommodating space 400. Therein, said upper lid 300 and said base 200 are combined by means of interlocking However, in practice, said upper lid 300 and said base 200 may be alternatively combined by means of screw fastening.

A cover plate 500 covers on a surface opposite to the surface where said upper lid 300 is combined with said base 200 for protecting said upper lid 300 from being damaged due to impact as well as creating a nice appearance; wherein said cover plate 500 and said upper lid 300 are combined in the manner of interlocking

A main circuit board 410 is disposed in said accommodating space 400 for managing electric power and information.

An amplifier module 420 is disposed in said accommodating space 400 for broadcasting audio messages.

A shooting module 430 is disposed in said accommodating space 400 for capturing images.

An audio input module 440 is disposed in said accommodating space 400 for inputting audio messages.

A button module 450 is disposed in said accommodating space 400 and exposed on the surfaces of said upper lid 300 and said cover plate 500 for sending visiting messages, wherein a periphery of said button module 450 is designed to be waterproof, enhancing the waterproof effect of the outdoor security communication device 1.

A status display module 460 is disposed in said accommodating space 400 and exposed on the surfaces of said upper lid 300 and said cover plate 500 for displaying operation statuses of said outdoor security communication device 1, wherein said status display module 460 is a set of signal components capable of emitting lights of various colors representing different statuses, and in practical application, said status display module 460 may be an image display panel for displaying video messages.

A shooting auxiliary unit 461 is disposed in said accommodating space 400 and exposed on the surface of said upper lid 300 and cover plate 500, capable of emitting light to enhance the shooting resolution, said shooting auxiliary unit 461 being an infrared light emitting diode (IR-LED).

Finally, an antenna module 470 is disposed in said accommodating space 400 for wirelessly sensing objects with particular tags such as an access card, wherein access is granted through the wireless sensing of the access card and said antenna module 470, access is granted, adding the access control function to said outdoor security communication device 1.

By the detailed description of the overall structure and technical content of the present invention, the following advantages of the present invention can be derived:

1. In the outdoor security communication device of the present invention, there are the first waterproof washer disposed on the periphery of the base where the base is combined with the fixing substrate; the second waterproof washer disposed between the upper lid and the base; and the inclined plane disposed on the base to exclude water. Via these structures, water prevention and removal effects of the outdoor security communication device can be enhanced, and preventing that water permeates into the accommodating space and damages the electronic components therein.

2. In the outdoor security communication device of the present invention, a anti-thief shrapnel is disposed on the base, and anti-thief mechanism can be triggered by this anti-thief shrapnel to prevent thieves from stealing the outdoor security communication device.

What is claimed is:

1. An outdoor security communication device comprising:
a fixing substrate being a plate structure and attached to a particular outside wall surface;
a base being combined onto said fixing substrate and comprising:
a first waterproof washer being disposed on peripheries of said base and said fixing substrate, said peripheries making the combination of said base and said fixing substrate, in order to prevent that water permeates from a joint border of said base and said fixing substrate into said outdoor security communication device;
a groove being disposed on a surface of said base, which combining with said fixing substrate by said surface, and having an inclined plane, wherein the water is removed by said groove and said inclined plane; and
an anti-thief shrapnel being disposed on the surface where said base is combined with said fixing substrate, wherein when said base and said fixing substrate are separated by an external force, said anti-thief shrapnel being then deformed so as to trigger an anti-thief system;
an upper lid being combined with said base to form an accommodating space, wherein a second waterproof washer is disposed on a joint border of said upper lid and said base for preventing that the water permeates from said joint border of said upper lid and said base into said accommodating space;
a cover plate covering on a surface opposite to the surface where said upper lid is combined with said base for protecting said upper lid from being damaged due to impact;
a main circuit board being disposed in said accommodating space for managing electrical power and information;
an amplifier module being disposed in said accommodating space for broadcasting audio messages;
a shooting module being disposed in said accommodating space for capturing images;
an audio input module being disposed in said accommodating space for inputting audio messages; and
a button module being disposed in said accommodating space and exposed on surfaces of said upper lid and said cover plate for sending visiting messages.

2. The outdoor security communication device of claim 1, wherein said fixing substrate is made of metal.

3. The outdoor security communication device of claim 1, wherein said fixing substrate is attached to said particular outside wall by means of screw fastening.

4. The outdoor security communication device of claim 1, wherein said base is combined with said fixing substrate by means of screw fastening.

5. The outdoor security communication device of claim 1 further comprising a status display module disposed in said accommodating space and exposed on the surfaces of said upper lid and said cover plate for displaying operation statuses of said outdoor security communication device.

6. The outdoor security communication device of claim 1 further comprising an antenna module disposed in said accommodating space for wirelessly sensing objects with particular tags.

7. The outdoor security communication device of claim 1, wherein said upper lid and said base are combined by means of interlocking.

8. The outdoor security communication device of claim 1, wherein said upper lid and said base are combined by means of screw fastening.

9. The outdoor security communication device of claim 1, wherein said cover plate and said upper lid are combined by means of interlocking.
